(19) United States
(12) Patent Application Publication
(10) Pub. No.: US 2022/0206869 A1
(43) Pub. Date: Jun. 30, 2022

(54) VIRTUALIZING RESOURCES OF A MEMORY-BASED EXECUTION DEVICE

(71) Applicant: ADVANCED MICRO DEVICES, INC., Santa Clara, CA (US)

(72) Inventors: VAIBHAV RAMAKRISHNAN RAMACHANDRAN, WEST LAFAYETTE, IN (US); ALEXANDRU DUTU, BELLEVUE, WA (US); BRADFORD BECKMANN, BELLEVUE, WA (US)

(21) Appl. No.: 17/135,209

(22) Filed: Dec. 28, 2020

(51) Int. Cl. G06F 9/50; G06F 9/48; G06F 9/52; G06F 3/06

(52) U.S. Cl. CPC G06F 9/5077; G06F 9/4881; G06F 9/52; G06F 3/0673; G06F 3/0659; G06F 3/0664; G06F 3/0604

(57) ABSTRACT

Virtualizing resources of a memory-based execution device is disclosed. A host processing system orchestrates the execution of two or more offload tasks on a remote execution device. The remote execution device includes a memory array coupled to a processing unit that is shared by concurrent processes on the host processing system. The host processing system provides time-multiplexed access to the processing unit by each concurrent process for completing offload tasks on the processing unit. The host processing system initiates a context switch on the remote execution device from a first offload task to a second offload task. The context state of the first offload task is saved on the remote execution device.

### BACKGROUND

Computing systems often include a number of processing resources (e.g., one or more processors), which may retrieve and execute instructions and store the results of the executed instructions to a suitable location. A processing resource (e.g., central processing unit (CPU) or graphics processing unit (GPU)) can comprise a number of functional units such as arithmetic logic unit (ALU) circuitry, floating point unit (FPU) circuitry, and/or a combinatorial logic block, for example, which can be used to execute instructions by performing arithmetic operations on data. For example, functional unit circuitry may be used to perform arithmetic operations such as addition, subtraction, multiplication, and/or division on operands. Typically, the processing resources (e.g., processor and/or associated functional unit circuitry) may be external to a memory array, and data is accessed via a bus or interconnect between the processing resources and the memory array to execute a set of instructions. To reduce the amount of accesses to fetch or store data in the memory array, computing systems may employ a cache hierarchy that temporarily stores recently accessed or modified data for use by a processing resource or a group of processing resources. However, processing performance may be further improved by offloading certain operations to a memory-based execution device in which processing resources are implemented internal and/or near to a memory, such that data processing is performed closer to the memory location storing the data rather than bringing the data closer to the processing resource. A memory-based execution device may save time by reducing external communications (i.e., processor to memory array communications) and may also conserve power.

### BRIEF DESCRIPTION OF THE DRAWINGS

FIG. 1 sets forth a block diagram of an example system for virtualizing resources of a memory-based execution device according to embodiments of the present disclosure.

FIG. 2 sets forth a block diagram of another example system for virtualizing resources of a memory-based execution device according to embodiments of the present disclosure.

FIG. 3 sets forth a block diagram of another example system for virtualizing resources of a memory-based execution device in accordance with embodiments of the present disclosure.

FIG. 4 sets forth a flow chart illustrating another example method of virtualizing resources of a memory-based execution device in accordance with embodiments of the present disclosure.

FIG. 5 sets forth a flow chart illustrating another example method of virtualizing resources of a memory-based execution device in accordance with embodiments of the present disclosure.

FIG. 6 sets forth a flow chart illustrating another example method of virtualizing resources of a memory-based execution device in accordance with embodiments of the present disclosure.

FIG. 7 sets forth a flow chart illustrating another example method of virtualizing resources of a memory-based execution device in accordance with embodiments of the present disclosure.

### DETAILED DESCRIPTION

Remote execution devices may be used by processors (e.g., central processing units (CPUs) and graphic processing units (GPUs)) to speed up computations that are memory intensive. These remote execution devices may be implemented in or near memory to facilitate the fast transfer of data. One example of a remote execution device is a processing-in-memory (PIM) device. PIM technology is advantageous in the evolution of massively multi-parallel systems like GPUs. To implement PIM architectures in such systems, PIM architectures should work in multi-process and multi-tenant environments. A PIM architecture allows some of the processor's computations to be offloaded to PIM-enabled memory banks to offset data transfer times and speed up overall execution. To speedup memory intensive applications, PIM-enabled memory banks contain local storage and an arithmetic logic unit (ALU) that allow perform computation at the memory level. However, resource virtualization for PIM devices is lacking. The lack of this virtualization of resources restricts the current execution model of PIM-enabled task streams to a sequential execution model, where a PIM task must execute all its instructions to completion and write all its data to the bank before ceding control of the PIM banks to the next task in the stream. However, such an execution model is extremely inefficient and degrades performance for massively parallel systems like GPUs where multiple tasks must co-execute in order to efficiently utilize the compute power and memory bandwidth available. Additionally, GPUs may provide independent forward progress guarantees for kernels in different queues since the introduction of Open Computing Language (OpenCL) queues and Compute Unified Device Architecture (CUDA) streams with the lack of PIM resource virtualization breaks these guarantees.

Embodiments in accordance with the present disclosure provide resource virtualization for remote execution devices such as PIM-enabled systems. For example, PIM resource virtualization facilitates handling of multiple contexts from different in-flight tasks and may provide significant performance improvements over sequential execution in PIM-enabled systems. Resource virtualization of remote execution device described herein can ensure correct execution by maintaining the independent forward progress guarantees at the PIM task level. The resource virtualization techniques described herein allow PIM architectures to execute concurrent applications, thereby improving system performance and overall utilization. These techniques are well suited for applications such as memory intensive applications, graphical applications as well as machine learning applications.

An embodiment is directed to a method of virtualizing resources of a memory-based execution device. The method includes orchestrating the execution of two or more offload tasks on a remote execution device and initiating a context switch on the remote execution device from a first offload task to a second offload task. In some implementations, orchestrating the execution of two or more offload tasks on the remote execution device includes concurrently scheduling the two or more offload tasks in two or more respective queues and, at the outset of a task execution interval, selecting one offload task from the two or more queues for access to the remote execution device. In some examples, the task execution interval is a fixed amount of time allotted to each of the two or more offload tasks and each of the two or more queues is serviced for a duration of the task execution interval according to a round-robin scheduling policy.

In some implementations, initiating a context switch on the remote execution device from a first offload task to a second offload task includes initiating the storing of context state data in context storage on the remote execution device. In some implementations, the method also includes restoring the context of the second offload task in the remote execution device.

In some implementations, the remote execution device includes a processing-in-memory (PIM) unit coupled to a memory array. In these implementations, the two or more offload tasks are PIM tasks. In various examples, the context storage may be located in a reserved section of the memory array coupled to the PIM unit or in a storage buffer of a memory interface component coupled to the remote execution device.

Another embodiment is directed to a computing device for virtualizing resources of a memory-based execution device. The computing device is configured to orchestrate the execution of two or more offload tasks on a remote execution device and initiate a context switch on the remote execution device from a first offload task to a second offload task. In some implementations, orchestrating the execution of two or more offload tasks on the remote execution device includes concurrently scheduling the two or more offload tasks in two or more respective queues and, at the outset of a task execution interval, selecting one offload task from the two or more queues for exclusive access to the remote execution device.

In some implementations, initiating a context switch on the remote execution device from a first offload task to a second offload task includes initiating the storing of context state data in context storage on the remote execution device. In some implementations, the computing device is further configured to restore the context of the second offload task in the remote execution device.

In some implementations, the remote execution device includes a processing-in-memory (PIM) unit coupled to a memory array and wherein the two or more offload tasks are two or more PIM tasks. In various example, the context storage is located in a reserved section of the memory array coupled to the PIM unit or in a storage buffer of a memory interface component coupled to the remote execution device.

Yet another embodiment is directed to a system for virtualizing resources of a memory-based execution device. The system comprises a processing-in-memory (PIM) enabled memory device and a computing device communicatively coupled to the PIM-enabled memory device. The computing device is configured to orchestrate the execution of two or more PIM tasks on the PIM-enabled memory device and initiate a context switch on the PIM-enabled memory device from a first PIM task to a second PIM task. In some implementations, orchestrating the execution of two or more PIM tasks on the PIM-enabled memory device includes concurrently scheduling the two or more PIM tasks in two or more respective queues and, at the outset of a task execution interval, selecting one PIM task from the two or more queues for exclusive access to the PIM-enabled memory device.

In some implementations, initiating a context switch on the PIM-enabled memory device from a first PIM task to a second PIM task includes initiating the storing of context state data in context storage on the PIM-enabled memory device. In some implementations, the computing device is further configured to restore the context of the second offload task in the remote execution device.

In various implementations, the PIM-enabled memory device includes a PIM execution unit coupled to a memory array and the context storage is located in a reserved section of the memory array.

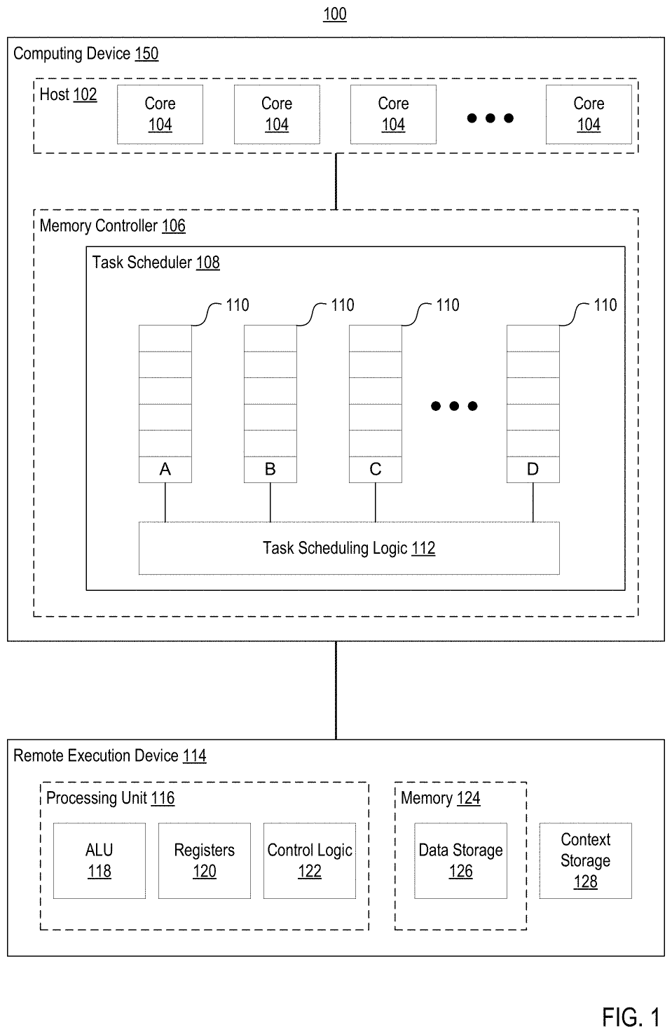

Embodiments in accordance with the present disclosure will be described in further detail beginning with FIG. 1. Like reference numerals refer to like elements throughout the specification and drawings. FIG. 1 sets forth a block diagram of an example system 100 for virtualizing resources of a memory-based execution device in accordance with the present disclosure. The example system of FIG. 1 includes a computing device 150 that includes one or more processor cores 104. In some examples, the cores 104 are CPU cores or GPU cores that are clustered as a compute unit in an application host 102. For example, a host 102 may be a compute unit that includes caches, input/output (I/O) interfaces, and other processor structures that are shared among some or all of the cores 104. The host 102 may host a multithreaded application or kernel such that the cores 104 execute respective threads of the multithreaded application or kernel. The computing device 150 also includes at least one memory controller 106 that is shared by two or more cores 104 for accessing a memory device (e.g., a dynamic random access memory (DRAM)) device. While the example of FIG. 1 depicts a single memory controller 106, the computing device may include multiple memory controllers each corresponding to a memory channel in a memory device. In some implementations, the memory controller 106 and the host 102 including the cores 104 are constructed in the same system-on-chip (SoC) package or multichip module. For example, in a multi-die semiconductor package, each core 104 may be implemented on a respective processor die and the memory controller(s) is implemented on an I/O die through which the cores 104 communicate with remote devices (e.g., memory devices, network interface devices, etc.).

In some examples, the memory controller 106 is also used by the host 102 for offloading tasks for remote execution. In these examples, an offload task is a set of instructions or commands that direct a device external to the computing device 150 to carry out a sequence of operations. In this way, the workload on the cores 104 is alleviated by offloading the task for execution on the external device. For example, the offload task may be a processing-in-memory (PIM) task that includes a set of instructions or commands that direct a PIM device to carry out a sequence of operations on data stored in a PIM-enabled memory device.

The example system 100 of FIG. 1 also includes one or more remote execution devices 114 coupled to the computing device 150 such that a remote execution device 114 is configured to execute tasks offloaded from the computing device 150. The remote execution device 114 and the computing device 150 share access to the same data produced and consumed by an application executing on the host 102. For example, this data may be data stored in data storage 126 in a memory array 124 of the remote execution device 114 or in a memory device (not shown) coupled to both the remote execution device 114 and the computing device 150. The remote execution device 114 is characterized by faster access to data relative to the host 102 as well as a smaller set of operations that can be executed relative the host 102. In some examples, the remote execution device 114 is operated at the direction of the host 102 to execute memory intensive tasks. For example, the remote execution device 114 may be a PIM device or PIM-enabled memory device, an accelerator device, or other device to which host-initiated tasks may be offloaded for execution. In one example, the remote execution device 114 includes a PIM-enabled memory die or PIM-enabled memory bank. For example, the remote execution device 114 may include a PIM-enabled high bandwidth memory (HBM) or a PIM-enabled a dual in-line memory module (DIMM), a chip or die thereof, or a memory bank thereof.

In the example of FIG. 1, the remote execution device 114 receives instructions or commands from the computing device 150 to carry out tasks issued from the cores 104. The instructions are executed on the remote execution device 114 in one or more processing units 116 that include control logic 122 for decoding instructions transmitted by the computing device 150, loading data from data storage 126 into one or more registers 120, and directing an arithmetic logic unit (ALU) 118 to perform an operation indicated in the instruction. The ALU 118 is capable performing a limited set of operations relative to the ALUs of the cores (104), thus making the ALU 118 less complex to implement and more suited to in-memory application. The result of the operation is written back to registers 120 before being committed, when applicable, back to data storage 126. The data storage 126 may be embodied in a memory array 124 such as a memory bank or other array of memory cells that is located in the remote execution device 114.

In some examples, the remote execution device 114 is a PIM-enabled memory device and the processing unit 116 is a PIM unit that is coupled to a memory array 124 corresponding to a bank of memory within the PIM-enabled memory device. In other examples, the remote execution device 114 is a PIM-enabled memory device and the processing unit 116 is a PIM unit that is coupled to multiple memory arrays 124 corresponding to multiple banks of memory within the PIM-enabled memory device. In one example, the remote execution device 114 is a PIM-enabled DRAM bank that includes a PIM unit (i.e., a processing unit 116) coupled to a DRAM memory array. In another example, the remote execution device 114 is a PIM-enabled DRAM die that includes a PIM unit (i.e., a processing unit 116) coupled to multiple DRAM memory arrays (i.e., multiple memory banks) on the die. In yet another example, the remote execution device 114 is a PIM-enabled stacked HBM that includes a PIM unit (i.e., a processing unit 116) on a memory interface die coupled to a memory array (i.e., memory bank) in a DRAM core die. Readers of skill in the art will appreciate that various configurations of PIM-enabled memory devices may be employed without departing from the spirit of embodiments of the present disclosure. In alternative examples, the remote execution device 114 includes an accelerator device (e.g., an accelerator die or Field Programmable Gate Array (FPGA) die) as the processing unit 116 that is coupled to a memory device (e.g., a memory die) that includes the memory array 124. In these examples, the accelerator device and memory device may be implemented in the same die stack or in the same semiconductor package. In such examples, the accelerator device is closely coupled to the memory device such that the accelerator can access data in the memory device faster than the computing device 150 can in most cases.

The example system 100 of FIG. 1 also includes a task scheduler 108 that receives tasks designated for remote execution on the remote execution device from the cores 104 and issues those tasks to the remote execution device 114. In the example depicted in FIG. 1, the task scheduler 108 is implemented in the memory controller 106; although, in other examples, the task scheduler 108 may be implemented in other components of the computing device 150. At times, different processes or process threads may require access to the same process units and memory arrays, or the same memory channel that includes processing units and memory arrays, to complete a task. Consider an example where four tasks corresponding to four concurrent processes executing on the host 102 all target the memory array 124 and are assigned for execution on the remote execution device 114 in the processing unit 116. In one approach, the computing device 150 issues all instructions for one task until that task is complete before issuing instructions for another task. To achieve greater execution efficiency and mitigate against starving other processes of resources, the task scheduler 108 includes multiple task queues 110 for concurrently scheduling tasks received from the host 102 for execution on the remote execution device 114. In some implementations, the number of task queues 110 corresponds to the number of concurrent processes, or to the number of virtual machine identifiers (VMIDs), supported by the host 102.

Task scheduling logic 112 in the task scheduler 108 performs a time-multiplexed scheduling between multiple tasks in the task queues 110 that are concurrently scheduled, where each task is given the full bandwidth of the processing unit 116 and memory array 124 to perform its operations. For example, in the example of FIG. 1, each task concurrently scheduled task A, B, C, and D is provided exclusive use of the processing unit 116, and thus exclusive use of the registers 120, for executing instructions in the task for a period of time. The task scheduling logic 112 services each task queue 110 in round-robin order at a regular interval. The interval of execution may be determined based on the balance between fairness and throughput. For example, if the measured overhead to perform the context switch between two tasks is X μsecs, then the execution interval for each task could be set at 100X μsecs to ensure only a <=1% impact on throughput. To provide more fairness in allowing each task the opportunity to execute its instructions, the execution interval could be decreased.

At the expiration of the interval, the currently executing task is preempted and a context switch to the next task is carried out. In some implementations, the task scheduling logic 112 carries out the context switch by directing the processing unit 116 to store its register state in context storage 128. The context storage 128 may be partitioned in the memory array 124 or located in a separate buffer of the remote execution device 114.

Consider an example where the remote execution device 114 is a PIM-enable memory bank that includes a PIM unit (i.e., processing unit 116) coupled to the memory array 124, and where tasks A, B, C, and D are concurrently scheduled PIM tasks (i.e., sets of PIM instructions to be executed in the PIM unit of the PIM-enabled memory bank). As a trivial example, each task includes instructions for the PIM unit to load some data from the memory array 124 into the registers 120, perform an arithmetic operation on the data in the ALU 118, write the result to the registers 120, and commit the result to the memory array 124. At the outset, task A is allowed to execute for Y μsecs by issuing the instructions of the task to the PIM unit for execution. After the execution interval elapses, task A is preempted to allow task B to execute. For example, the task scheduling logic 112 may send an instruction to the PIM unit to perform a context switch. The state of the registers 120 is saved to the context storage 128 in the remote execution device prior to beginning execution of instructions for task B. Task B is then allowed to execute for Y μsecs before being preempted for task C, and task C is then allowed to execute for Y μsecs before being preempted for task D. When task D is preempted for the execution of task A, the register state is restored from context storage 128, and the task scheduling logic 112 resumes issuing instructions for task A.

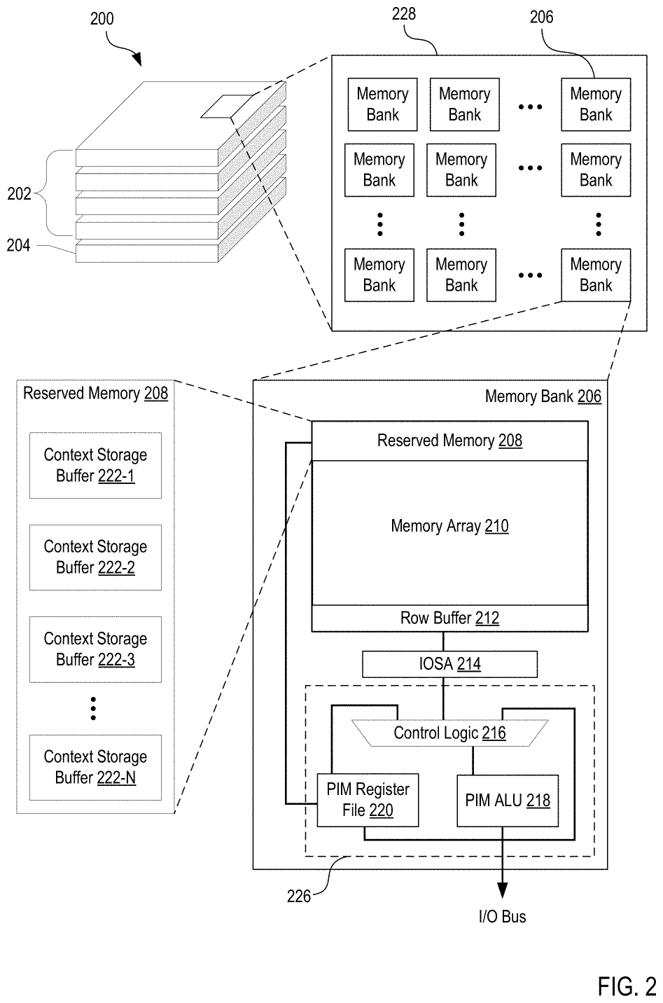

For further explanation FIG. 2 sets forth a block diagram of an example of a PIM-enabled memory system 200 in accordance with embodiments of the present disclosure. In the example depicted in FIG. 2, the PIM-enabled memory system 200 is implemented as an HBM that includes multiple memory dies 202 (e.g., DRAM cores) stacked on a memory interface die 204 (e.g., a base logic die). A memory die 202 includes multiple memory banks 206 that are organized into channels or pseudo channels where memory banks in a channel or pseudo channel share an I/O bus. In the example depicted in FIG. 2, a pseudo channel 228 includes a number of memory banks 206, although readers will appreciate that the number of memory banks in a channel or pseudo channel may be selected by the memory system designer. The I/O bus is implemented by TSVs that connect each memory die 202 to the memory interface die 204. The memory interface die 204 is communicatively coupled to host processor system (e.g., the computing device 150 of FIG. 1) through a high-speed link (e.g., a interposer wafer). Commands and data that are received from a memory controller (e.g., memory controller 106 of FIG. 1) at the memory interface die 204 and routed to the appropriate channel or pseudo channel in a memory die 202, and to the target memory bank. The commands and data may include PIM commands and host-based data for executing those PIM commands in the PIM-enabled memory system 200.

In some examples, a memory bank 206 includes a memory array 210 that is a matrix of memory bit cells with word lines (rows) and bit lines (columns) that is coupled to a row buffer 212 that acts as a cache when reading or writing data to/from the memory array 210. For example, the memory array 210 may be an array of DRAM cells. The memory bank 206 also includes an I/O line sense amplifier (IOSA) 214 that amplifies data read from the memory array 210 for output to the I/O bus (or to a PIM unit, as will be described below). The memory bank 206 may also include additional components not shown here, such as a row decoder, column decoder, command decoder, as well as additional sense amplifiers, drivers, signals, and buffers.

In some embodiments, a memory bank 206 includes a PIM unit 226 that performs PIM computations using data stored in the memory array 210. The PIM unit 226 includes a PIM ALU 218 capable of carrying out basic computations within the memory bank 206, and a PIM register file 220 that includes multiple PIM registers for storing the result of a PIM computation as well as for storing data from the memory array and/or host-generated data that are used as operands of the PIM computation. The PIM unit 226 also includes control logic 216 for loading data from the memory array 210 and host-generated data from the I/O bus into the PIM register file 220, as well for writing result data to the memory array 210. When a PIM computation or sequence of PIM computations is complete, the result(s) in the PIM register file 220 are written back to the memory array 210. By virtue of its physical proximity to the memory array 210, the PIM unit 226 is capable of completing a PIM task faster than if operand data were transmitted to the host for computation and result data was transmitted back to the memory array 210.

As previously discussed, a PIM task may include multiple individual PIM instructions. The result of the PIM task is written back to the memory array 210; however, intermediate data may be held the PIM register file 220 without being written to the memory array 210. Thus, to support preemption of a PIM task on a PIM unit 226 by a task scheduler (e.g., task scheduler 108 of FIG. 1) of a host computing device (e.g., computing device 150 of FIG. 1), the PIM-enabled memory system 200 supports storage buffers for storing the context state (i.e., register state) of the PIM task that is preempted.

In some embodiments, the memory array 210 includes reserved memory 208 that stores context state data for PIM tasks executing on the PIM unit 226. In some implementations, the reserved memory 208 includes distinct context storage buffers 222-1, 222-2, 222-3 . . . 222-N corresponding to N processes supported by the host processor system (e.g., computing device 150 of FIG. 1). For example, if the host processor system can support N concurrent processes, then each context storage buffer corresponds to a respective VMID of the concurrent processes. When a PIM task is preempted (e.g., when signaled by the task scheduler), the register state of the register file 220 is saved to a context storage buffer in the reserved memory 208. When the task is subsequently resumed by the task scheduler, the register state for that task is restored to the register file 220 from the context storage buffer in the reserved memory 208. In some cases, the reserved memory 208 is only be accessible by the PIM unit 226 is not be visible to the host processor system. For example, if the host processor system sees that there is 4 GB of DRAM available, there is actually 4.5 GB available where the extra 512 MB is only visible to the PIM unit 226 for storing PIM contexts. An advantage to having the context storage buffers in the memory bank as opposed to elsewhere is the higher access bandwidth and speed in the context switching process, as there no need to load context data from outside of the memory bank or memory die.

In alternative examples to the example depicted in FIG. 2, a PIM unit 226 may be coupled to multiple memory banks 206 such that the memory banks share the resources of the PIM unit 226. For example, a PIM unit 226 may be shared among memory banks 206 in the same channel or pseudo channel, or on the same memory die 202. In such examples, the context storage buffers 222-1, 222-2, 222-3 . . . 222-N may be implemented in reserved memory 208 of the respective memory banks 206 or in a global context storage that stores context state data for all of the memory banks 206 that share the PIM unit 226 (e.g., an on-die global context storage).

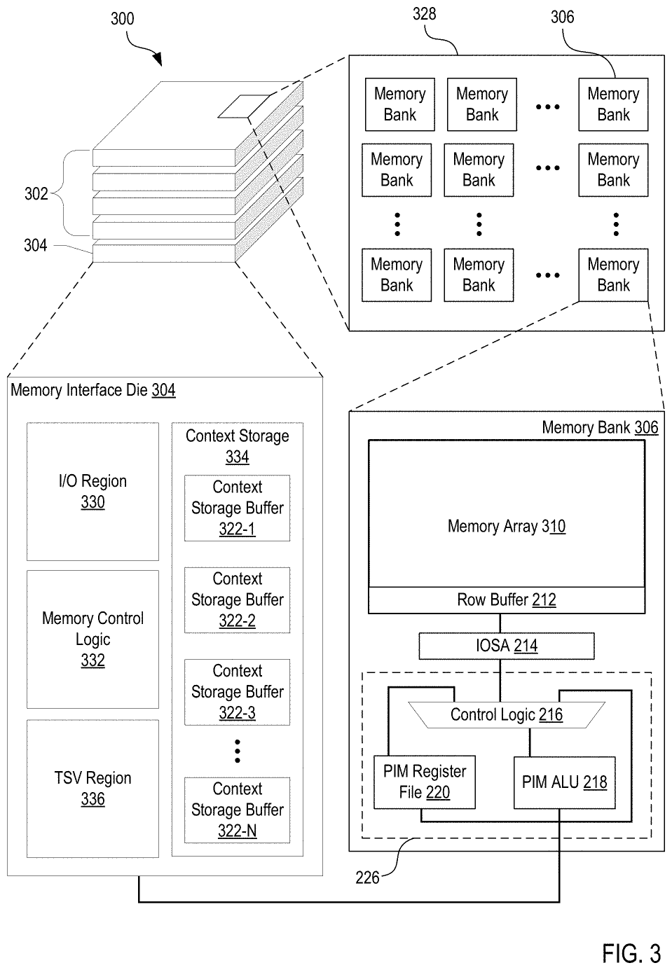

For further explanation FIG. 3 sets forth a block diagram of an example of a PIM-enabled memory system 300 in accordance with embodiments of the present disclosure. Like the example depicted in FIG. 2, the PIM-enabled memory system 200 depicted in FIG. 3 is implemented as an HBM that includes multiple memory dies 202 (e.g., DRAM cores) stacked on a memory interface die 204 (e.g., a base logic die). A memory die 302 includes multiple memory banks 306 that are organized into channels or pseudo channels where memory banks in a channel or pseudo channel share an I/O bus. In the example depicted in FIG. 2, a pseudo channel 328 includes a number of memory banks 306, although readers will appreciate that the number of memory banks in a channel or pseudo channel may be selected by the memory system designer. The I/O bus is implemented by TSVs that connect each memory die 302 to a TSV region 336 on the memory interface die 304. The memory interface die 304 is communicatively coupled to host processor system (e.g., the computing device 150 of FIG. 1) through an I/O region 330 (e.g., a PHY region) coupled to a high-speed link (e.g., a interposer wafer). Commands and data that are received from a host system memory controller (e.g., memory controller 106 of FIG. 1) at the memory interface die 304 and routed to the appropriate channel or pseudo channel in a memory die 302 by memory control logic 332. The commands and data may include PIM commands and host-based data for executing those PIM commands in the PIM-enabled memory system 300.

In some examples, like the memory bank 206 in FIG. 2, a memory bank 306 includes a memory array 310 that is a matrix of memory bit cells with word lines (rows) and bit lines (columns). The memory bank 306 also includes a row buffer 212, IOSA 214, and PIM unit 226 like the memory bank 206 in FIG. 2, as well as additional components not shown here, such as a row decoder, column decoder, command decoder, as well as additional sense amplifiers, drivers, signals, and buffers. The memory bank 306 in FIG. 3 is different from the memory bank 206 in FIG. 2 in that the memory bank 306 does not include reserved memory for storing context states of PIM tasks.

In some embodiments, the memory interface die 304 includes a context storage area 334 that stores context state data for PIM tasks executing on the PIM unit 226. In some implementations, the context storage area 334 includes distinct context storage buffers 322-1, 322-2, 322-3 . . . 322-N corresponding to N processes supported by the host processor system (e.g., computing device 150 of FIG. 1). For example, if the host processor system can support N concurrent processes, then each context storage buffer corresponds to a respective VMID of the concurrent processes. When a PIM task is preempted (e.g., when signaled by the task scheduler), the register state of the register file 220 is saved to a context storage buffer in the context storage area 334. When the task is subsequently resumed by the task scheduler, the register state for that task is restored to the register file 220 from the context storage buffer in the context storage area 334. When the context storage buffers are located in the memory interface die 304, there should be sufficient area available to store the context of all the PIM registers for all PIM units in the channel or pseudo channel. The context storage area 334 in the memory interface die 304 is implicitly hidden from the host processor system and can only be accessed by the PIM unit 226, thus there is no need to over-provision the memory banks and hide the extra storage from the system. The use of the memory interface die 304 to store the context state data of the PIM register files 220 may take advantage of already existing empty real estate on the memory interface die 304, thus introducing no space overhead.

In alternative examples to the example depicted in FIG. 3, one or more PIM units 226 serving a memory channel may be implemented on the memory interface die 304 instead of within the memory banks 306 or on the memory die 302. In such examples, data from the memory array must be passed down to the memory interface die 304 for performing the PIM computation, and then written back to the memory array 310 on the memory die 302. In additional alternative examples, one or more PIM units 226 may be implemented on an accelerator die (not shown) that is stacked on top of the memory dies 302 and coupled to the memory dies 302 via TSVs. In such examples, data from the memory array must be passed up to the accelerator die for performing the PIM computation, and then written back to the memory array 310 on the memory die 302.

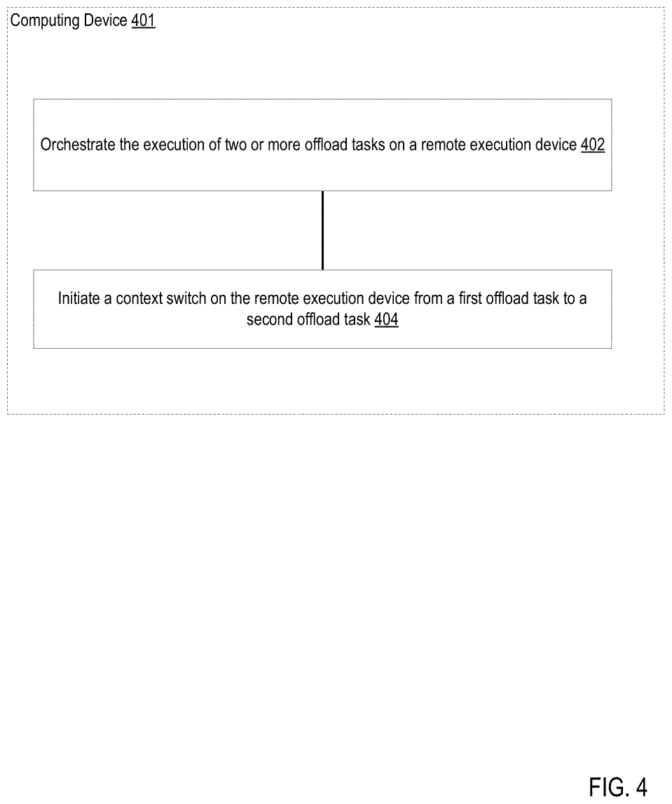

For further explanation, FIG. 4 sets forth a flow chart illustrating an example method of virtualizing resources of a memory-based execution device in accordance with the present disclosure. The example of FIG. 4 includes a computing device 401 that may be similar in configuration to the computing device 150 of FIG. 1. For example, the computing device 401 may include a host processor system, a memory controller, and an offload task scheduler. The method of FIG. 4 includes orchestrating 402 the execution of two or more offload tasks on a remote execution device. In some examples, orchestrating 402 the execution of two or more offload tasks on a remote execution device is carried out by a memory controller receiving offload task requests from a host processor system (e.g., the host 102 of FIG. 1). For example, two or more process concurrently executing on one or more processor cores of the host system may issue requests for remote execution of a task by a remote execution device. The offload task may correspond to a kernel of code that is to be offloaded for execution on the remote execution device, in that the offload task represents a transaction including a particular sequence of instructions that are to be completed on the remote execution device. In these examples, orchestrating 402 the execution of two or more offload tasks on a remote execution device is further carried out by placing the offload tasks in distinct task queues. For example, each task queue corresponds to the two or more concurrently executing processes on the host system. In one example, each task queue corresponds to a virtual machine identifier that identifies a process or thread executing on the host system. In these examples, orchestrating 402 the execution of two or more offload tasks on a remote execution device is further carried out by issuing commands/instructions for completing each offload task to the remote execution device. In some examples, a task scheduling unit includes task scheduling logic for placing offload tasks into task queues according to their process, thread, or virtual machine identifier, and issuing the commands/instructions for completing the offload task to the remote execution device in accordance with an offload task scheduling policy.

In one example, the offload tasks are PIM tasks that are to be remotely executed by a PIM-enabled memory device. A PIM task includes a set of PIM instructions that are to be executed by a PIM unit in the PIM-enabled memory device that are dispatched by the same offload task from a computing device. The PIM unit includes a PIM ALU and a PIM register file for executing the PIM instructions of the PIM task. The memory controller of a computing device issues the PIM instructions to the remote PIM-enabled memory device over a memory channel that includes the PIM unit. The PIM unit executes the PIM instructions within the PIM-enabled memory device. For example, the PIM unit may include a PIM unit (e.g., ALU, registers, and control logic) coupled to a memory array (e.g., in a memory bank) of the PIM-enabled memory device.

The example method of FIG. 4 also includes initiating 404 a context switch on the remote execution device from a first offload task to a second offload task. In some examples, initiating 404 a context switch on the remote execution device from a first offload task to a second offload task is carried out by an offload task scheduler (e.g., task scheduler 108 of FIG. 1) deciding to preempt an offload task that is currently executing and switch execution to another offload task. Here, “currently executing” means that the memory controller is in the process of issuing offload task commands/instructions for execution on the remote execution device, such that additional offload task commands/instructions remain in queue to complete the offload task. In these examples, initiating 404 a context switch on the remote execution device from a first offload task to a second offload task is further carried out by the offload task scheduler sending a message to the remote execution device indicating that a context switch is occurring.

Continuing the above example of a PIM-enabled memory device, the remote execution resources shared by the first offload task and the second offload task are PIM unit resources, including the PIM ALU and PIM register file. By supporting the preemption of PIM tasks in the offload task scheduler, the resources of the PIM unit in the PIM-enabled memory device may be virtualized. A context switch from a first PIM task to a second task, initiated by the offload task scheduler, causes the storing of the register state of registers in the PIM register file for the first and initialization of the PIM register file for the executing the second task.

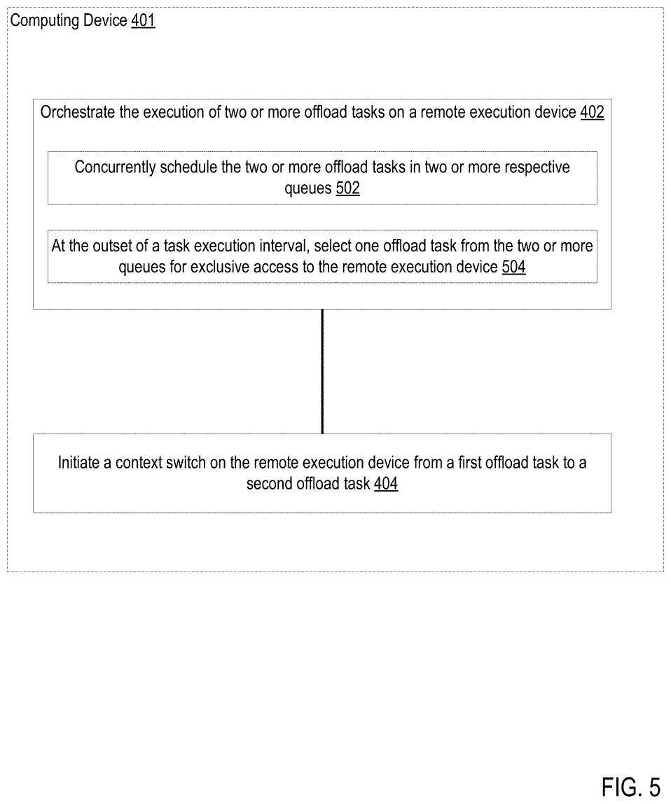

For further explanation, FIG. 5 sets forth a flow chart illustrating another example method of virtualizing resources of a memory-based execution device in accordance with the present disclosure. Like the method of FIG. 4, the method of FIG. 5 includes orchestrating 402 the execution of two or more offload tasks on a remote execution device and initiating 404 a context switch on the remote execution device from a first offload task to a second offload task. In the method of FIG. 5, orchestrating 402 the execution of two or more offload tasks on a remote execution device includes concurrently scheduling 502 the two or more offload tasks in two or more respective queues. In some examples, scheduling 502 the two or more offload tasks in two or more respective queues is carried out by the offload task scheduler receiving offload task instructions/commands for the first offload task and the second offload task where the offload tasks correspond to distinct processes/threads on the host processor system. In these examples, scheduling 502 the two or more offload tasks in two or more respective queues is further carried out by the offload task scheduler creating a queue entry for each offload task in a task queue corresponding to the respective process/thread of the offload task. For example, the first offload task in scheduled in a first task queue corresponding to a first process/thread and the second offload task in scheduled in a second task queue corresponding to a second process/thread. When the first offload task and the second offload task are at the head of their respective task queues, the first offload task and the second offload task are concurrently scheduled for execution on the remote execution device, in that exclusive use of the remote execution device (e.g., a PIM unit and memory array of a PIM-enabled memory bank) is time sliced between the first offload task and the second offload task.

In the method of FIG. 5, orchestrating 402 the execution of two or more offload tasks on a remote execution device further includes, at the outset of a task execution interval, selecting 504 one offload task from the two or more queues for exclusive access to the remote execution device. In some examples, task scheduling logic of the task scheduler schedules offload tasks for execution on the remote execution device for an allotted amount of time in accordance with a task scheduling policy. In one implementation, the task scheduling policy is a round-robin policy where each concurrently scheduled offload task is allotted an equal amount of time for exclusive access to the remote execution device to execute the offload task. In these examples, upon the expiration of an interval representing the amount of time allotted to the first task in the first task queue, a second task from the second task queue (that is concurrently scheduled) is selected for execution on the remote execution device at the outset of the next interval (i.e., the task execution interval outset). The task scheduler services each task queue for the allotted duration of time to allow the concurrently scheduled tasks in those queues to execute. For example, task A in task queue 1 is allowed to execute for X seconds, then task B in task queue 2 is allowed to execute for X seconds, then task C in task queue 3 is allowed to execute for X seconds, and then task D in task queue 4 is allowed to execute for X seconds. Where task queues 1-4 are the only task queues with concurrently scheduled tasks, task queue 1 is selected again in accordance with a round robin scheduling policy.

Continuing the above example of a PIM-enabled memory device, PIM tasks are generated by processes/threads executing on processor cores of the host processor system and transmitted to the memory controller. PIM tasks are concurrently scheduled in PIM queues by the task scheduler for execution on the PIM-enabled memory device. Each concurrently scheduled PIM task in the PIM queues is allotted an amount of time for executing PIM tasks before being preempted to allow another PIM task in a different PIM queue to execute. Each PIM task includes a stream of instructions/commands that are issued to the remote PIM-enabled device from the memory controller. This stream is interrupted at the expiration of the interval so that a new stream corresponding to a second PIM task is allowed to issue for its allotted interval.

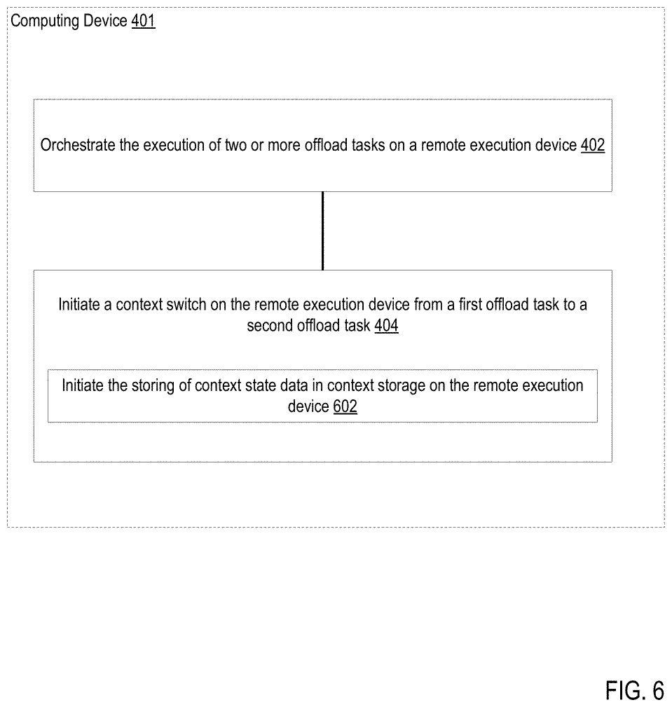

For further explanation, FIG. 6 sets forth a flow chart illustrating another example method of virtualizing resources of a memory-based execution device in accordance with the present disclosure. Like the method of FIG. 4, the method of FIG. 6 includes orchestrating 402 the execution of two or more offload tasks on a remote execution device and initiating 404 a context switch on the remote execution device from a first offload task to a second offload task. In the method of FIG. 6, initiating 404 a context switch on the remote execution device from a first offload task to a second offload task includes initiating 602 the storing of context state data in context storage on the remote execution device. In some examples, initiating 602 the storing of context state data in context storage on the remote execution device is carried out by the task scheduler transmitting an instruction to the remote execution device that a context switch is occurring, thereby indicating that the current state of the register file in the remote execution unit should be stored in a context storage on the remote execution device. In response to receiving this instruction, the remote execution device saves the state of the register file in a processing unit executing the offload task commands/instructions and any other state information for the offload task in a context storage buffer corresponding to the process, thread, or VMID associated with the offload task. The register file of the processing unit is then initialized by loading a saved context from another context storage buffer or clearing the register file.

In one example, the remote execution device is implemented in a memory die of a memory device and the context storage buffer is located on memory die with the remote execution device. For example, a stacked memory device (e.g., an HBM) includes multiple memory die cores and a base logic die. In this example, the context storage buffer is located on the same die or within the same memory bank as the remote execution device (e.g., a PIM unit). In another example, the remote execution device is implemented in a memory die of a memory device and the context storage buffer is located on a die that is separate from the memory die that includes the remote execution device. For example, a stacked memory device (e.g., an HBM) includes multiple memory die cores and a base logic die. In this example, the context storage buffer is located on the base logic die and the remote execution device (e.g., a PIM unit) is implemented on a memory die core.

Continuing the above example of a PIM-enabled memory device, the PIM-enabled memory device may be an HBM stacked memory device that includes PIM-enabled memory banks. In this example, each PIM-enabled memory bank includes a memory array and a PIM unit for executing PIM computations coupled to the memory array. In one implementation, the memory array includes a reserved area for storing context data. In this implementation, in response to a context switch initiated by the offload task scheduler, the state of the register file is stored in the reserved area of the memory array in a context buffer corresponding to the VMID of the offload task. Context storage buffers for each VMID are included in the reserved area of the memory array. In another implementation, the base logic die includes a context storage area for storing context data. In this implementation, in response to a context switch initiated by the offload task scheduler, the state of the register file is stored in the context storage area of the base logic die in a context buffer corresponding to the VMID of the offload task. Context storage buffers for each VMID are included in the context storage area of the base logic die.

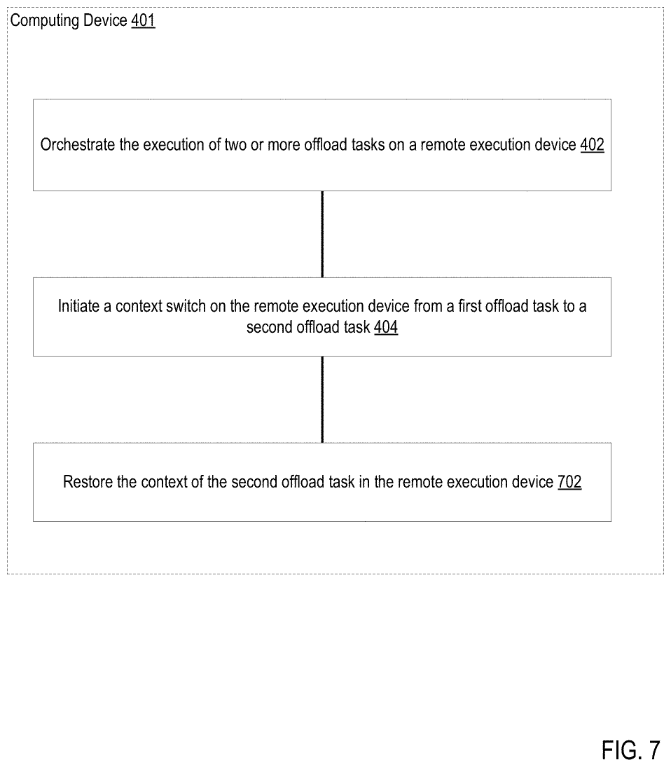

For further explanation, FIG. 7 sets forth a flow chart illustrating another example method of virtualizing resources of a memory-based execution device in accordance with the present disclosure. Like the method of FIG. 4, the method of FIG. 7 includes orchestrating 402 the execution of two or more offload tasks on a remote execution device and initiating 404 a context switch on the remote execution device from a first offload task to a second offload task. The method of FIG. 7 also includes restoring 702 the context of the second offload task in the remote execution device. In some examples, restoring 702 the context of the second offload task in the remote execution device is carried out by the remote execution device restoring the register state of an offload task that was previously preempted. For example, prior to executing the first offload task, the second offload task may have been preempted. In this case, the context (i.e., register state) of the second offload task has been stored in a context storage buffer on the remote execution device. In response to initiating the context switch from the first offload task to the second offload task, the stored register state of the second offload task is loaded from the context storage buffer on the remote execution device into the register file of the processing unit on the remote execution device.

Continuing the above example of a PIM-enabled memory device, a context storage buffer is provided for each process, thread, or VMID executing on the host processor system. When one PIM task is preempted by the task scheduling logic, the register state of the PIM register file in the PIM unit is saved to the context storage buffer. When the task scheduling logic subsequently returns to the preempted PIM task, the context data (i.e., stored register state) is loaded into the PIM register file from the context storage buffer, thus restoring the state of the PIM task to allowing for continued execution of the PIM task.

In view of the above disclosure, readers will appreciate that embodiments of the present disclosure support the virtualization of resources in a remote execution device. Where the complexity of processing units in the remote execution device is far reduced from the complexity of a host processing system (as with, e.g., a PIM-enabled memory device), support for the virtualization of processing resources in the remote execution device is achieved by a task scheduler in the host computing system that manages execution of tasks on the remote execution device and provides context switching for those tasks. Context storage buffers on the remote execution device facilitate the context switching orchestrated by the task scheduler. In this way, context switching on the remote execution device is supported without implementing task scheduling logic on the remote execution device and without tracking the register state of the remote execution device in the host processing system. Such advantages are particularly borne out in PIM devices where saved contexts may be quickly loaded from context storage buffers in the memory associated with the PIM device to facilitate switching execution from one PIM task to another. Accordingly, serial execution of PIM tasks and starving processes of PIM resources may be avoided.

Embodiments can be a system, an apparatus, a method, and/or logic circuitry. Computer readable program instructions in the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions.

Aspects of the present disclosure are described herein with reference to flowchart illustrations and/or block diagrams of methods, apparatus (systems), and logic circuitry according to some embodiments of the disclosure. It will be understood that each block of the flowchart illustrations and/or block diagrams, and combinations of blocks in the flowchart illustrations and/or block diagrams, can be implemented by logic circuitry.

The logic circuitry may be implemented in a processor, other programmable data processing apparatus, or other device to cause a series of operational steps to be performed on the processor, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIG.s illustrate the architecture, functionality, and operation of possible implementations of systems, methods, and logic circuitry according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the FIG.s. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

While the present disclosure has been particularly shown and described with reference to embodiments thereof, it will be understood that various changes in form and details may be made therein without departing from the spirit and scope of the following claims. Therefore, the embodiments described herein should be considered in a descriptive sense only and not for purposes of limitation. The present disclosure is defined not by the detailed description but by the appended claims, and all differences within the scope will be construed as being included in the present disclosure.

What is claimed is:

1. A method of virtualizing resources of a memory-based execution device, the method comprising:
orchestrating execution of two or more offload tasks on a remote execution device; and
initiating a context switch on the remote execution device from a first offload task to a second offload task.

2. The method of claim 1, wherein orchestrating the execution of two or more offload tasks on the remote execution device includes:
concurrently scheduling the two or more offload tasks in two or more respective queues; and
at a task execution interval outset, selecting one offload task from the two or more queues for access to the remote execution device.

3. The method of claim 2, wherein the task execution interval is a fixed amount of time allotted to each of the two or more offload tasks; and wherein each of the two or more queues is serviced for a duration of the task execution interval according to a round-robin scheduling policy.

4. The method of claim 1, wherein initiating a context switch on the remote execution device from a first offload task to a second offload task includes initiating the storing of context state data in context storage on the remote execution device.

5. The method of claim 4, wherein the remote execution device includes a processing-in-memory (PIM) unit coupled to a memory array and wherein the two or more offload tasks are two or more PIM tasks.

6. The method of claim 5, wherein the context storage is located in a reserved section of the memory array coupled to the PIM unit.

7. The method of claim 5, wherein the context storage is located in a storage buffer of a memory interface component coupled to the remote execution device.

8. The method of claim 1 further comprising restoring a context of the second offload task in the remote execution device.

9. A computing device for virtualizing resources of a memory-based execution device, the computing device configured to:
orchestrate execution of two or more offload tasks on a remote execution device; and
initiate a context switch on the remote execution device from a first offload task to a second offload task.

10. The computing device of claim 9, wherein orchestrating the execution of two or more offload tasks on the remote execution device includes:
concurrently scheduling the two or more offload tasks in two or more respective queues; and
at a task execution interval outset, selecting one offload task from the two or more queues for access to the remote execution device.

11. The computing device of claim 9, wherein initiating a context switch on the remote execution device from a first offload task to a second offload task includes initiating the storing of context state data in context storage on the remote execution device.

12. The computing device of claim 11, wherein the remote execution device includes a processing-in-memory (PIM) unit coupled to a memory array and wherein the two or more offload tasks are two or more PIM tasks.

13. The computing device of claim 12, wherein the context storage is located in a reserved section of the memory array coupled to the PIM unit.

14. The computing device of claim 12, wherein the context storage is located in a storage buffer of a memory interface component coupled to the remote execution device.

15. The computing device of claim 9, wherein the computing device is further configured to restore a context of the second offload task in the remote execution device.

16. A system for virtualizing resources of a memory-based execution device, the system comprising:
a processing-in-memory (PIM) enabled memory device; and
a computing device communicatively coupled to the PIM-enabled memory device, wherein the computing device is configured to:
orchestrate execution of two or more PIM tasks on the PIM-enabled memory device; and
initiate a context switch on the PIM-enabled memory device from a first PIM task to a second PIM task.

17. The system of claim 16, wherein orchestrating the execution of two or more PIM tasks on the PIM-enabled memory device includes:
concurrently scheduling the two or more PIM tasks in two or more respective queues; and
at a task execution interval outset, selecting one PIM task from the two or more queues for access to the PIM-enabled memory device.

18. The system of claim 16, wherein initiating a context switch on the PIM-enabled memory device from a first PIM task to a second PIM task includes initiating the storing of context state data in context storage on the PIM-enabled memory device.

19. The system of claim 18, wherein the PIM-enabled memory device includes a PIM execution unit coupled to a memory array; and wherein the context storage is located in a reserved section of the memory array.

20. The system of claim 16, wherein the computing device is further configured to restore a context of the second PIM task in the PIM-enabled memory device.
